(19) United States
(12) Patent Application Publication
(10) Pub. No.: US 2001/0031290 A1
(43) Pub. Date: Oct. 18, 2001

(54) Screen for extrusion granulating device

(76) Inventors: Akira Iwata, Kobe-shi (JP); Takehiko Inoue, Kobe-shi (JP)

Correspondence Address: BACON & THOMAS, PLLC, 625 Slaters Lane, 4th Floor, Alexandria, VA, 22314-1176, US

(21) Appl. No.: 09/828,954

(22) Filed: Apr. 10, 2001

(30) Foreign Application Priority Data
Apr. 18, 2000 (JP) P 2000-115958

(51) Int. Cl. B28B 3/20

(52) U.S. Cl. 425/331; 425/464

(57) ABSTRACT

An inner die hole (3) communicates with an outer relief hole (5) having a diameter larger than that of the inner die hole (3) concentrically through a stepped portion (4). A screen (1) has a thickness (T) set larger than a diameter (d1) of the inner die hole (3). The inner die hole (3) has a depth (h1) set substantially equal to the diameter (d1) thereof. The outer relief hole (5) has a depth (h2) set to a remainder (T-h1) of the thickness (T).

### BACKGROUND OF THE INVENTION

1. Field of the Invention

The present invention relates to an extrusion granulating device which extrudes and granulates a material to be granulated, which consists of, for example, wet powdery pharmaceuticals, chemical flavoring, detergent, food or the like, through die holes of a screen by a roller scraper or a knife-like scraper and more particularly to a screen for use with the extrusion granulating device.

2. Explanation of Related Art

There is known a conventional example of the extrusion granulating device of this type as shown in FIGS. 2 and 3. Here, FIG. 2 is a plan view of a granulating portion of the conventional extrusion granulating device. FIG. 3 is a perspective view of the extrusion granulating device provided with the granulating portion. The extrusion granulating device 10 comprises a machine body 11 having an upper portion where a cylindrical screen 1 is fixedly provided. The screen 1 is provided at a mid portion of its interior area with a rotation driving shaft 12. The rotating driving shaft 12 is provided with a roller scraper 13. The scraper 13 extrudes and granulates a wet material 8a to be granulated, through die holes of the screen 1 to form columnar granulated product 8b.

As shown in FIG. 2, the scraper 13 comprises, for example, three arms 14 each of which projects from the rotation driving shaft 12 so as to be able to effect a resilient push, and rollers 15 pivoted at the respective front ends of the arms 14 so as to be able to roll. When the rotation driving shaft 12 is rotated in a direction indicated by an arrow (A), the respective rollers 15 roll in a direction indicated by an arrow (B) in pressure contact with an inner peripheral surface of the screen 1. The respective rollers 15 extrude the wet material 8a through the die holes of the screen 1 to granulate it into columnar one.

Conventionally, the screen 1 is formed from a punching metal and the die holes are opened by punching. Therefore, the conventional technique experienced a restriction when working the die holes and the screen 1 had a thickness set smaller than a diameter of a die hole. In FIG. 3, numeral 16 indicates a hopper fixedly provided at an upper portion of the screen 1. Numeral 17 designates a rotary table which rotates in a direction indicated by an arrow (C) with the granulated product 8b placed thereon. Numeral 18 indicates a fence which prevents dispersion of the granulated product 8b. Numeral 19 designates a guide plate which guides the granulated product 8b toward a discharge outlet 20.

### SUMMARY OF THE INVENTION

In the conventional technique, as mentioned above, the screen had a thickness smaller than a diameter of a die hole and therefore its compressive strength is weak. On the other hand, while performing the extrusion granulating, the scraper exerts a strong pushing force to the screen, so that the screen has such a short life as being undurable even for two days on a normal condition (that it works 8 hours per day). This entails a problem that the running cost of the extrusion granulating device becomes extremely high.

In view of the above, the present invention has been created and aims at providing a screen for use with an extrusion granulating device which can extend its durable term by remarkably augmenting the compressive strength to thereby greatly reduce the running cost of the extrusion granulating device.

In order to accomplish the above aim, the present invention has constructed a screen for the extrusion granulating device as follows.

An invention of claim 1 comprises an inner die hole 3 and an outer relief hole 5 having a diameter larger than that of the inner die hole 3, the inner die hole 3 communicating with the outer relief hole 5 concentrically through a stepped portion 4, and has a thickness (T) set larger than a diameter (d1) of the inner die hole 3, for example, as shown in FIG. 1(D). Here, a material 8a to be granulated is extruded from the inner die hole 3 of the screen 1 to the outer relief hole 5.

In the screen for the extrusion granulating device as set forth in claim 1, an invention of claim 2 sets a depth (h1) of the inner die hole 3 substantially equal to the diameter (d1) of the inner die hole 3 and a depth (h2) of the outer relief hole 5 to a remainder (T-h1) gained by deducting the depth (hi) from the thickness (T).

In the screen for the extrusion granulating device as set forth in claim 2, an invention of claim 3 first drills the outer relief hole 5 to the predetermined depth (h2) and then drills the inner die hole 3 with a recess 5a at a front end of the outer relief hole 5, which was formed on drilling the outer relief hole 5, taken as a guide.

Function and Effect of the Invention

(a) The invention of claim 1 communicates the inner die hole 3 with the outer relief hole 5 having the diameter larger than that of the inner die hole 3 concentrically through the stepped portion 4 and sets the thickness (T) of the screen larger than the diameter (d1) of the inner die hole 3. Therefore, even if the scraper exerts a strong pushing force to the screen when effecting the extrusion granulating, the screen augments its compressive strength which resists the strong pushing force, much more than the conventional one. This results in extending the durable term of the screen to greatly reduce the running cost of the extrusion granulating device.

(b) In the screen for the extrusion granulating device as set forth in claim 1, the invention of claim 2 sets the depth (h1) of the inner die hole 3 substantially equal to the diameter (d1) of the inner die hole 3 as well as the conventional technique. This can set the strength of the pushing force which the scraper exerts to the screen on effecting the extrusion granulating, to substantially the same as that of the conventional technique. On the other hand, the outer relief hole 5 has its depth (h2) set to the remainder (T-h1) gained by deducting the depth (h1) from the thickness (T). Thus the screen increases its thickness more than that of the conventional one by an amount corresponding to the depth (h2) of the outer relief hole 5. More specifically, it is possible to set the strength of the pushing force exerted by the scraper when effecting the extrusion granulating to substantially the same as that of the conventional technique, while remarkably augmenting the compressive strength of the screen by increasing its thickness. This can more extend the durable term of the screen.

(c) In the screen for the extrusion granulating device as set forth in claim 2, the invention of claim 3 first drills the outer relief hole 5 to the predetermined depth (h2) and then drills the inner die hole 3 with the recess 5a at the front end of the outer relief hole 5, which was formed when drilling the outer relief hole 5, taken as a guide. This facilitates the drilling of the inner die hole 3 and improves concentricity of the outer relief hole with the inner die hole. In consequence, the granulated product 8b pushed out of the inner die hole 3 to the outer relief hole 5 through the stepped portion 4 slightly bulges owing to a reaction of the pushing, but it does not make an eccentric contact with an inner wall surface of the outer relief hole thanks to a good concentricity of the outer relief hole with the inner die hole. Thus a beautiful granulated product is obtained.

### BRIEF DESCRIPTION OF THE DRAWINGS

FIG. 1(A) is a developed view of a cylindrical screen according to an embodiment of the present invention. FIG. 1(B) is a plan view of the cylindrical screen. FIG. 1(C) is an enlarged view of an essential portion (C) in FIG. 1(A). And FIG. 1(D) is an enlarged sectional view of an inner die hole and an outer relief hole, which are essential portions of the cylindrical screen;

FIG. 2 is a plan view of a granulating portion of an extrusion granulating device according to prior art; and

FIG. 3 is a perspective view of the extrusion granulating device.

### DESCRIPTION OF THE PREFERRED EMBODIMENTS

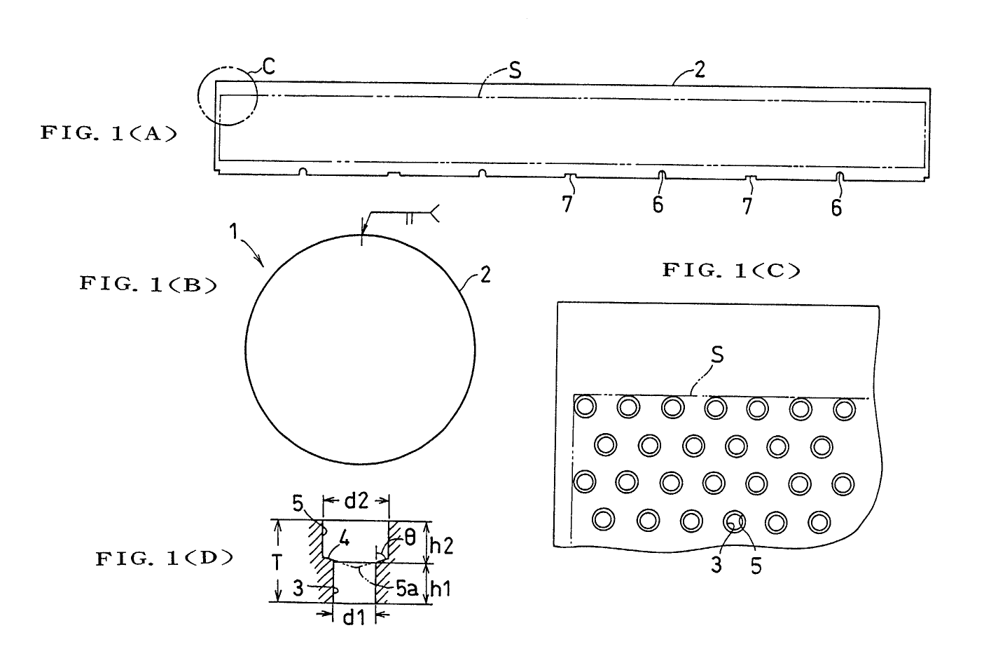

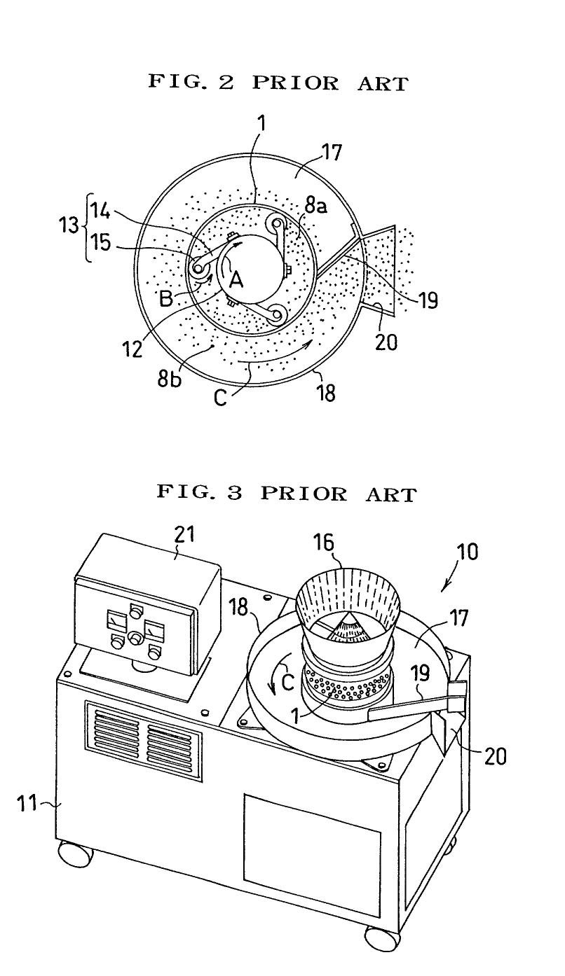

Hereafter, explanation is given for an embodiment of the present invention based on the drawings. FIG. 1 shows a screen for an extrusion granulating device, according to an embodiment of the present invention. FIG. 1(A) is a developed view of a cylindrical screen. FIG. 1(B) is a plan view of the cylindrical screen. FIG. 1(C) is an enlarged view of an essential portion (C) in FIG. 1(A). FIG. 1(D) is an enlarged sectional view of an inner die hole and an outer relief hole, which are essential portions of the cylindrical screen.

The cylindrical screen 1 is manufactured by forming a horizontally long steel plate 2 made of stainless steel and shown in FIG. 1(A) into a cylindrical shape as shown in FIG. 1(B) and welding opposite ends to each other. The steel plate 2 has a granulating zone (S) within which a large number of inner die holes 3 are opened as shown in FIG. 1(C). In FIG. 1(A), numerals 6 and 7 show a recess for engaging in screw-thread fitting relationship and a recess for positioning, respectively.

Within the granulating zone (S) of the steel plate 2, mutually adjoining optional inner die holes 3 are arranged so that each of them constitutes a vertex of an equilateral triangle. Every inner die hole 3 communicates with an outer relief hole 5 having a diameter larger than that of the inner die hole 3 concentrically through a stepped portion 4. The screen 1 has a thickness (T) set sufficiently larger than a diameter (d1) of the inner die hole 3. This is in an attempt to remarkably augment the compressive strength of the screen 1 which resists the scraper 13 when effecting the extrusion granulating.

For instance, in the case where the screen 1 has a thickness (T) set twice a diameter (d1) of an inner die hole 3, the screen 1 comes to have a compressive strength which is theoretically four times of the diameter (d1) [(T/d1)²]. Accordingly, if the thickness (T) of the screen 1 is properly set, it is possible to extend the durable term of the screen up to several times of that of the conventional one and to thereby greatly reduce the running cost of the extrusion granulating device.

The inner die hole 3 has a depth (h1) substantially equal to the diameter (d1) of the inner die hole 3 and the outer relief hole 5 has a depth (h2) set to a remainder (T-h1) gained by deducting the depth (h1) from the thickness (T). This is in an attempt to restrict the strength of the pushing force which the scraper 13 exerts to the screen 1 on effecting the extrusion granulating to substantially the same as that of the conventional one, while increasing the thickness (T) of the screen 1 more than the conventional one by an amount corresponding to the depth (h2) of the outer relief hole 5 to thereby augment its compressive strength.

More specifically, in the event that the inner die hole 3 has the depth (h1) set equal to the thickness (T) of the screen 1, it is necessary to augment the pushing force which the scraper 13 exerts to the screen 1 when effecting the extrusion granulating by an amount corresponding to the increase of the thickness (T). Thus the compressive strength of the screen 1 cannot be augmented in proportion to the increase of the thickness (T). On the other hand, in this embodiment, while the screen 1 has the thickness (T) increased more than the conventional one by an amount corresponding to the depth (h2) of the outer relief hole 5 to thereby remarkably augment the compressive strength, it is possible to set the strength of the pushing force of the scraper 13 when effecting the extrusion granulating to substantially the same as that of the conventional one. This can much more extend the durable term of the screen 1.

The stepped portion 4 is formed by first drilling the outer relief hole 5 to the predetermined depth (h2) and then drilling the inner die hole with a recess 5a at a front end of the outer relief hole 5, which was formed when drilling the outer relief hole 5, taken as a guide. This is in an attempt to facilitate the drilling of the inner die hole 3 and to improve the concentricity of the outer relief hole 5 with the inner die hole 3. Owing to this attempt, the granulated product pushed out of the inner die hole 3 to the outer relief hole 5 through the stepped portion 4 slightly bulges. But it does not make an eccentric contact with an inner wall surface of the outer relief hole 5 thanks to a good concentricity of the outer relief hole 5 with the inner die hole 3. Thus a beautiful granulated product is obtained.

A relief angle (θ) of the stepped portion 4 is determined by a leading end angle of a drill which drills the outer relief hole 5. Therefore, if the drill has its leading end angle properly set, it is possible to adequately set the relief angle (θ) of the stepped portion 4. In this embodiment, the drill has its leading end angle set to about 150 degrees and the relief angle (θ) is set to about 75 degrees. However, taking it into consideration that the granulated product bulges when it has been pushed out to the outer relief hole 5, the relief angle (θ) is preferably set to 90 degrees, if possible.

In the present embodiment, while maintaining an opening ratio in the granulating zone (S) within a range of 24 to 40%, the cylindrical screen was manufactured for test in the following various manners.

A first Test Example

The screen has the thickness (T) of 6.0 mm. The inner die hole has its diameter (d1) and its depth (h1) set to 3.8 mm and 3.0 mm, respectively. The outer relief hole 5 has its diameter (d2) and its depth (h2) set to 4.0 mm and 3.0 mm, respectively.

A second Test Example

The screen has the thickness (T) of 4.0 mm. The inner die hole has both of its diameter (d1) and its depth (h1) set to 1.0 mm. The outer relief hole 5 has its diameter (d2) and its depth (h2) set to 1.5 mm and 3.0 mm, respectively.

A third Test Example

The screen has the thickness (T) of 2.5 mm. The inner die hole has both of its diameter (d1) and its depth (h1) set to 1.0 mm. The outer relief hole 5 has both of its diameter (d2) and its depth (h2) set to 1.5 mm.

In any one of the above Test Examples, the screen augmented its compressive strength remarkably and extended its durable term to some ten times of that of the conventional one to result in the possibility of greatly reducing the running cost.

The present invention is applicable not only to the roller scraper but also widely to a case where a material to be granulated is pushed out of die holes by a knife-like scraper for granulation and to the other extrusion granulating devices. Further, the present invention is applicable not only to the cylindrical screen but also widely to all type of the extrusion granulating devices by being adapted thereto.

What is claimed is:

1. A screen for an extrusion granulating device comprising an inner die hole (3) and an outer relief hole (5) having a diameter larger than that of the inner die hole (3), the inner die hole (3) communicating with the outer relief hole (5) concentrically through a stepped portion (4), and having a thickness (T) set large than a diameter (d1) of the inner die hole (3).

2. The screen for the extrusion granulating device as set forth in claim 1, wherein the inner die hole (3) has a depth (h1) set substantially equal to the diameter (d1) of the inner die hole (3) and the outer relief hole (5) has a depth (h2) set to a remainder (T-h1) gained by deducting the depth (h1) from the thickness (T).

3. The screen for the extrusion granulating device as set forth in claim 2, wherein first the outer relief hole (5) is drilled to the predetermined depth (h2) and then the inner die hole (3) is drilled with a recess (5a) at a front end of the outer relief hole (5), which was formed when drilling the outer relief hole (5), taken as a guide.
